(19) United States
(12) Patent Application Publication
(10) Pub. No.: US 2007/0217783 A1
(43) Pub. Date: Sep. 20, 2007

(54) Lens assembly and camera

(75) Inventor: Yasunori Nishijima, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/717,646

(22) Filed: Mar. 14, 2007

(30) Foreign Application Priority Data
Mar. 14, 2006 (JP) 2006-069255

(51) Int. Cl. G03B 17/00

(52) U.S. Cl. 396/448

(57) ABSTRACT

A lens assembly includes a lens barrel. A photographing lens system is contained in the lens barrel, and has a first lens on an objective side. A lens opening is formed in the lens barrel, for passing object light toward the first lens. A lens cover blade closes the lens opening in an openable manner for protection. Support shafts movably support the first lens. A lens moving cam device with an inclined cam surface moves the first lens along an optical axis in response to shifting of the lens cover blade. Furthermore, a cover shifting ring rotates when externally operated, for shifting the lens cover blade. A cover moving mechanism with a pin and hole shifts the lens cover blade when the cover shifting ring rotates. The lens moving cam device moves the first lens along the optical axis in response to rotation of the cover shifting ring.

### BACKGROUND OF THE INVENTION

1. Field of the Invention

The present invention relates to a lens assembly and camera. More particularly, the present invention relates to a lens assembly and camera in which a movable barrel can be contained in a simplified structure to reduce a space.

2. Description Related to the Prior Art

A camera of a collapsible type is known. A lens assembly has a lens barrel which is moved forwards toward an objective side before photographing an image. After this, the lens barrel is collapsed and contained. U.S. Pat. No. 6,522,482 (corresponding to JP-A 2002-277707), and JP-A 6-068499 and 9-281553 disclose a camera of a multi barrel structure. To change the total length of the lens assembly, plural movable barrels are included and movable in the optical axis direction. The multi barrel structure of a lens assembly makes it possible to reduce each length of the movable barrels to reduce a total size of the lens assembly when collapsed.

However, a length of the movable barrels must be great because of greatness of an amount of advance of lenses/lens groups in the lens assembly having a total lens length, particularly in a zoom lens. The greatness in the length of the movable barrels will increase a thickness of a camera body to contain the lens assembly. It is conceivable to increase the number of the movable barrels instead of increasing the length of the movable barrels. However, a problem arises in the higher complexity in the structure of the lens assembly.

### SUMMARY OF THE INVENTION

In view of the foregoing problems, an object of the present invention is to provide a lens assembly and camera in which a movable barrel can be contained in a simplified structure to reduce a space.

In order to achieve the above and other objects and advantages of this invention, a lens assembly includes a lens barrel. A photographing lens system is contained in the lens barrel, and having a first lens disposed on an objective side. A lens opening is formed in a front end of the lens barrel, for entry of object light to the first lens. A lens cover blade is movable between an open position to open the lens opening and a closed position to close the lens opening. A lens support mechanism supports the first lens movably along an optical axis between a front position and a rear position, wherein the first lens, when in the front position, is located in the lens opening at least partially, and when in the rear position, is positioned behind and away from the lens opening. A lens moving mechanism is responsive to shifting of the lens cover blade, for moving the first lens so as to prevent the lens cover blade from interfering with the first lens.

The lens barrel is movable forwards toward an objective side for photographing, and backwards after photographing for collapsing.

Furthermore, a cover moving mechanism shifts the lens cover blade in connection with the lens barrel, to set the lens cover blade in the open position when the lens barrel is moved forwards, and to set the lens cover blade in the closed position when the lens barrel is moved backwards for collapsing.

The lens moving mechanism is responsive to a shift of the lens moving mechanism, and the first lens, when the lens cover blade is moved to the open position, is set in the front position, and when the lens cover blade is moved to the closed position, is set in the rear position.

Furthermore, a cover shifting ring is rotated when externally operated, for shifting the lens cover blade.

The cover moving mechanism shifts the lens cover blade when the cover shifting ring is rotated. The lens moving mechanism includes a lens moving cam device for moving the first lens along the optical axis in response to rotation of the cover shifting ring.

Furthermore, a biasing device biases the first lens in a first direction along the optical axis. The lens moving cam device moves the first lens in a second direction against the biasing device in response to shifting of the lens cover blade.

The lens moving cam device includes a cam follower pin formed to project from a lens holder of the first lens. A cam block is formed to project from the cover shifting ring, having a cam surface, for pressing the cam follower pin when rotated, to move the first lens along the optical axis.

The lens support mechanism includes plural support shafts, secured to the lens barrel, for supporting the first lens.

In one preferred embodiment, the photographing lens system includes a second lens disposed behind the first lens. The lens support mechanism has a spring characteristic, and has first and second ends, the first end being secured to the first lens, the second end being secured to the second lens, for biasing the first lens toward the second lens.

In another preferred embodiment, the first lens is positioned in a lens holder and is set in the lens barrel with the lens holder. The lens support mechanism includes a guide channel formed inside the lens barrel to extend along the optical axis. A guide ridge is formed to project from the lens holder, and guided by the guide channel.

Furthermore, a rotational support mechanism supports the lens cover blade about a rotational center thereof. The cover moving mechanism includes a transmission pin for projecting from the lens cover blade. An engageable hole is formed in the cover shifting ring, for receiving an end of the transmission pin, and for rotating the transmission pin about the rotational center upon rotation of the cover shifting ring.

Furthermore, a front support panel constitutes a front of the lens barrel, the front support panel having the lens opening, and having the lens cover blade secured thereto by the rotational support mechanism. An insertion channel is formed through the front support panel, for receiving insertion of the transmission pin, to keep the transmission pin shiftable.

Furthermore, a cover closing cam device rotates the cover shifting ring in a closing direction when the lens barrel is in a back position for containing. A biasing mechanism biases the cover shifting ring in an opening direction.

Furthermore, a stationary panel is disposed behind the lens barrel, for supporting the lens barrel movably. The cover closing cam device includes a cam rod formed to project forwards from the stationary panel. A cam block is formed with the cover shifting ring, having a cam surface, for being pressed by the cam rod when the lens barrel is in the back position, to rotate the cover shifting ring in the closing direction.

Also, a camera includes a lens barrel. A photographing lens system is contained in the lens barrel, and has a first lens positioned on an objective side. A lens opening is formed in the lens barrel, for passing object light toward the first lens. A lens cover blade closes the lens opening in an openable manner for protection. A lens support mechanism movably supports the first lens along an optical axis. A lens moving mechanism moves the first lens along the optical axis in response to shifting of the lens cover blade.

Furthermore, a cover shifting ring is rotated when externally operated, for shifting the lens cover blade. The lens moving mechanism includes a lens moving cam device for moving the first lens along the optical axis in response to rotation of the cover shifting ring.

### BRIEF DESCRIPTION OF THE DRAWINGS

The above objects and advantages of the present invention will become more apparent from the following detailed description when read in connection with the accompanying drawings, in which:

FIG. 1 is an exploded perspective illustrating a lens assembly;

FIG. 2A is a cross section illustrating a state of the lens assembly with a movable barrel set backwards;

FIG. 2B is a cross section illustrating a state of the lens assembly with the movable barrel set forwards;

FIG. 3 is an exploded perspective illustrating of the movable barrel;

FIG. 4 is a front elevation illustrating a cover shifting ring;

FIG. 5 is a perspective illustrating the cover shifting ring;

FIG. 6A is a front elevation illustrating a closed state of the cover shifting ring;

FIG. 6B is a front elevation illustrating an open state of the cover shifting ring;

FIG. 7A is a side elevation illustrating a retracted state of a first lens holder;

FIG. 7B is a side elevation illustrating a protruded state of the first lens holder;

FIG. 8 is a cross section illustrating one preferred embodiment of which springs connect two lens holders;

FIG. 9 is a front elevation illustrating another preferred embodiment in which the first lens holder is guided by ridges and channels.

### DETAILED DESCRIPTION OF THE PREFERRED EMBODIMENT(S) OF THE PRESENT INVENTION

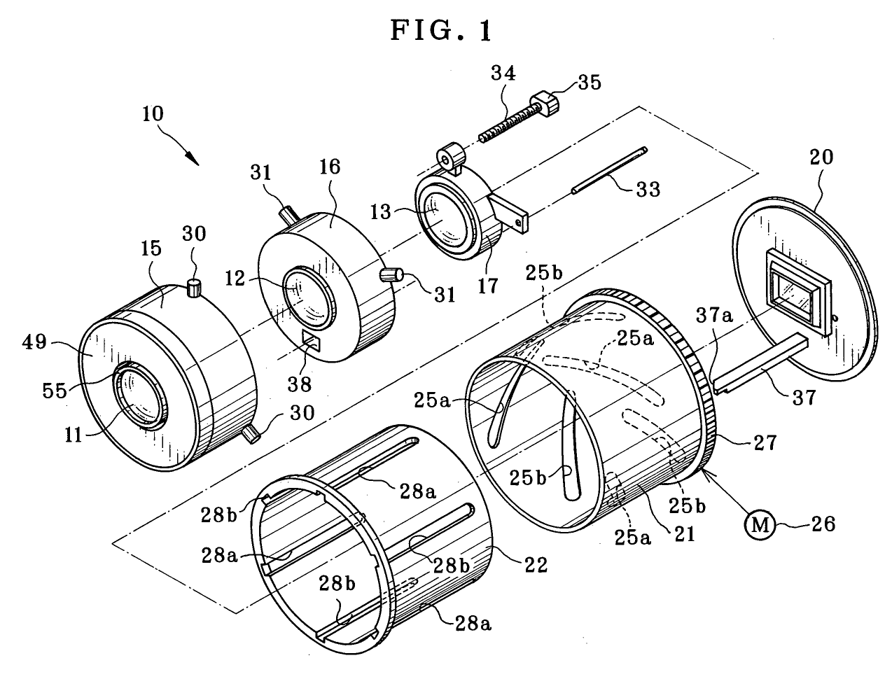

In FIG. 1, a zoom lens assembly 10 has a photographing lens system which includes a first lens/lens group 11, a second lens/lens group 12, and a third lens/lens group 13. A movable barrel 15 causes the first lens/lens group 11 to move back and forth in the optical axis direction. A second lens holder 16 supports the second lens/lens group 12. A third lens holder 17 supports the third lens/lens group 13. The zoom lens assembly 10 includes a stationary panel 20 or disk for support, a rotatable barrel 21, and a stationary barrel 22. An image pickup device 14 is fixed on the stationary panel 20. The rotatable barrel 21 rotates when driven. The stationary barrel 22 is fixed on the stationary panel 20, and disposed inside the rotatable barrel 21. The zoom lens assembly 10 is used in a digital still camera.

Cam grooves 25a and 25b are formed in the rotatable barrel 21, and operate for moving the movable barrel 15 and the second lens holder 16 in the optical axis direction upon rotation of the rotatable barrel 21. The cam grooves 25a operate to move the movable barrel 15, the cam grooves 25b operating to move the second lens holder 16. The cam grooves 25a and 25b are positioned alternately with one another in the circumferential direction of the rotatable barrel 21. The cam grooves 25a are disposed at an angular interval of 120 degrees from one another. Similarly, an interval of the cam grooves 25b is 120 degrees. A gear portion 27 is included in a rear end of the rotatable barrel 21. A motor 26 rotates to drive the gear portion 27 for the purpose of rotating the rotatable barrel 21.

Linear guide channels 28a and 28b are formed in the stationary barrel 22, and operate for moving the movable barrel 15 and the second lens holder 16 straight in the optical axis direction upon rotation of the rotatable barrel 21. The linear guide channels 28a guide the movable barrel 15 straight, the linear guide channels 28b guiding the second lens holder 16. The linear guide channels 28a and 28b are positioned alternately with one another in the circumferential direction of the stationary barrel 22. The linear guide channels 28a are disposed at an angular interval of 120 degrees from one another. Similarly, an interval of the linear guide channels 28b is 120 degrees.

Three cam pins 30 are formed on the movable barrel 15 for engagement with the cam grooves 25a and the linear guide channels 28a. The cam pins 30 are inserted through the linear guide channels 28a, so that their ends enter the cam grooves 25a. When the rotatable barrel 21 rotates, the cam pins 30 move along the linear guide channels 28a, and press edges of the cam grooves 25a. Thus, the movable barrel 15 is moved in the optical axis direction. Three cam pins 31 are formed on the second lens holder 16 for engagement with the cam grooves 25b and the linear guide channels 28b. In a manner similar to the movable barrel 15, the cam pins 31 for the second lens holder 16 move along the linear guide channels 28b, and press the cam grooves 25b. Thus, the second lens holder 16 is moved in the optical axis direction.

There are a slide shaft 33 and a screw 34 with threads, which support the third lens holder 17. The slide shaft 33 is secured to the stationary panel 20. The slide shaft 33 and the screw 34 extend in parallel with an optical axis. A motor 35 drives the screw 34, which rotates to move the third lens holder 17 in the optical axis direction. A barrier or cover closing cam rod 37 is fixed on the stationary panel 20, and operates to close barrier blades or lens cover blades while the movable barrel 15 is contained. A through hole 38 is formed in the second lens holder 16 for insertion of the cover closing cam rod 37.

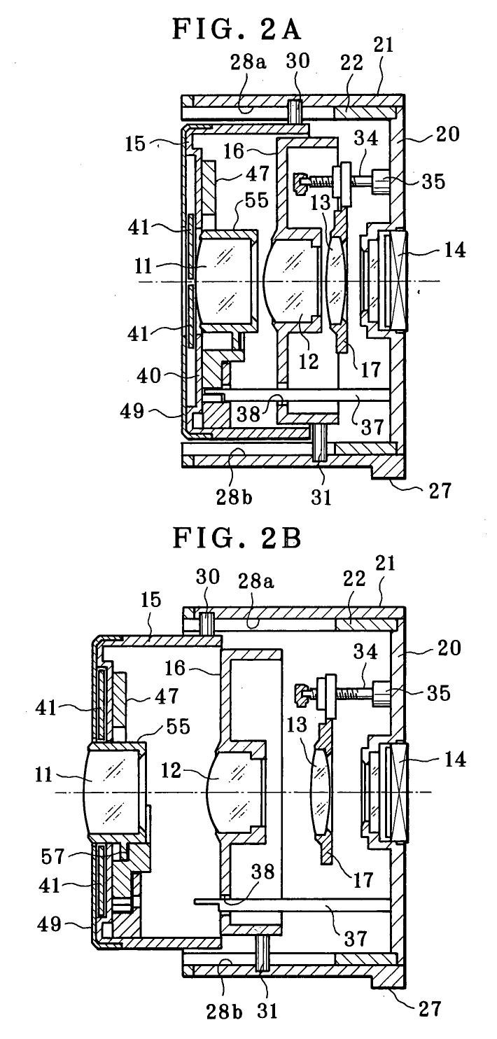

In FIG. 2A, the movable barrel 15 is contained in the stationary barrel 22 at the time of no photography. Also, the second and third lens holders 16 and 17 are set on the objective side of the photographing lens. The intervals between the first, second and third lenses/lens groups 11, 12 and 13 become smallest. In FIG. 2B, the movable barrel 15 moves forwards at the time of photography, and projects from the front of the stationary barrel 22. Also, the second and third lens holders 16 and 17 move forwards. The intervals between the first, second and third lenses/lens groups 11, 12 and 13 become greater, to enable photography. The positions of the first and second lenses/lens groups 11 and 12 change according to a zoom magnification. At the wide-angle end, a distance from the first lens/lens group 11 to the image plane is the maximum. At the telephoto end, the distance from the first lens/lens group 11 to the image plane is smaller. The third lens/lens group 13 is moved in the optical axis direction according to the object distance, and is used as a focus lens for focusing.

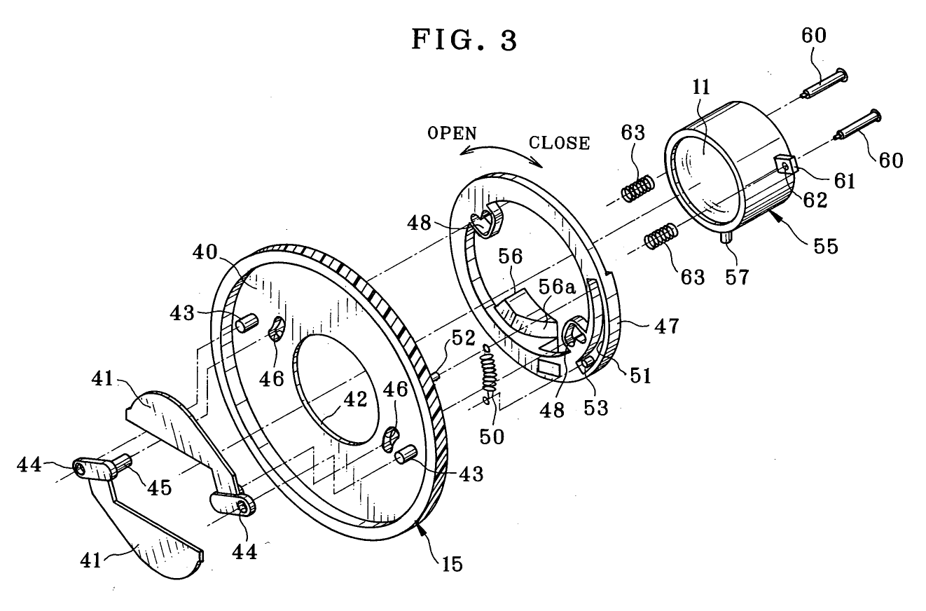

In FIG. 3, a front support panel 40 is one portion of the movable barrel 15. A pair of barrier blades or lens cover blades 41 are disposed on the front support panel 40. A lens opening 42 for entry is formed in the front support panel 40, and opened and closed by the lens cover blades 41. While the lens cover blades 41 are open, the first lens/lens group 11 appears through the lens opening 42. While the lens cover blades 41 are closed, the first lens/lens group 11 is protected from the outside. A rotational support shaft 43 is formed with the front support panel 40, and is each one of centers about which the lens cover blades 41 rotate. An axial hole 44 is formed in the lens cover blades 41 for insertion of the rotational support shaft 43. A transmission pin 45 as cover moving mechanism is formed with the lens cover blades 41. An arc shaped insertion channel 46 is formed in the front support panel 40, and receives insertion of the transmission pin 45. A barrier or cover shifting ring 47 for opening and closing the lens cover blades 41 is engaged with the transmission pin 45. A shape of the insertion channel 46 is defined to extend in a path of moving the transmission pin 45 upon shifting the lens cover blades 41. A ring shaped front panel 49 covers the front side of the lens cover blades 41.

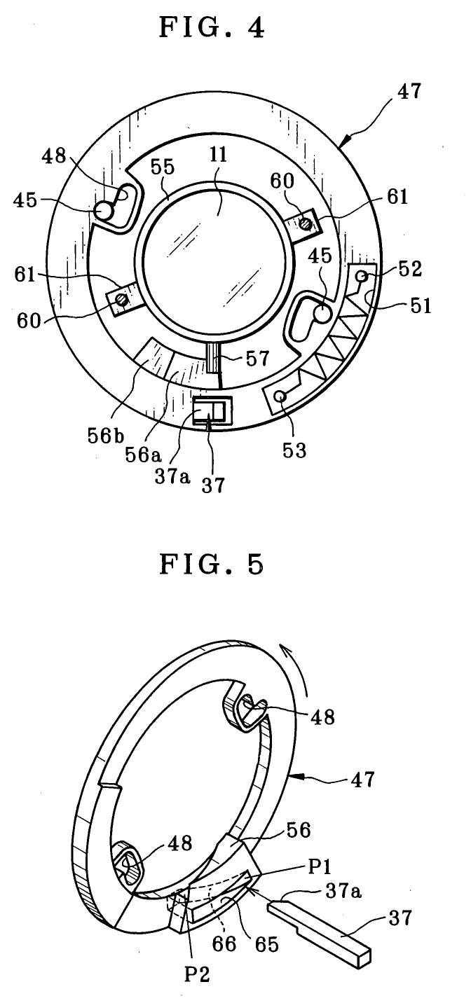

The cover shifting ring 47 is supported inside the movable barrel 15 and on the rear of the front support panel 40 in a rotatable manner. The cover shifting ring 47 rotates about the optical axis to open and close the lens cover blades 41. In FIG. 4, an engageable hole 48 in the cover moving mechanism is formed in the cover shifting ring 47, receives insertion of the transmission pin 45 and transmit rotation of the cover shifting ring 47 to the lens cover blades 41. The engageable hole 48 is formed in each one of portions of the cover shifting ring 47 projecting from its inner face. At each time that the cover shifting ring 47 rotates by a predetermined angle, the transmission pin 45 moves inside the engageable hole 48 and rotates about the rotational support shaft 43. Thus, the lens cover blades 41 shift for opening and closing.

A ring biasing tension coil spring 50 is associated with the cover shifting ring 47 and biases the lens cover blades 41 in a direction to open. A spring chamber 51 is formed in a front face of the cover shifting ring 47, has an arc shape, and contains the tension coil spring 50. The tension coil spring 50 is a biasing element, which may be any structure distinct from the tension coil spring. An end retention pin 52 protrudes from the rear side of the front support panel 40 of the movable barrel 15, and supports an upper end of the tension coil spring 50. An end retention pin 53 protrudes in an inner end of the spring chamber 51, and supports a lower end of the tension coil spring 50. The tension coil spring 50 biases the cover shifting ring 47 in the counterclockwise direction.

A lens moving cam block 56 as transmission mechanism is formed to project from the cover shifting ring 47. A first lens holder 55 has the first lens/lens group 11, and is moved by the lens moving cam block 56 toward the objective side. An inclined cam surface 56a is formed on one portion of the lens moving cam block 56, and moves the first lens holder 55 forwards by use of force of rotation of the cover shifting ring 47. A cam follower pin 57 projects from a lateral face of the first lens holder 55, and moves in contact with the lens moving cam block 56. When the cover shifting ring 47 rotates in a direction to open the lens cover blades 41, the inclined cam surface 56a of the lens moving cam block 56 presses the cam follower pin 57 forwards. The first lens holder 55 is moved forwards.

Two support shafts 60 are secured to the inside of the movable barrel 15 for supporting the first lens holder 55. A projection 61 projects from the lateral face of the first lens holder 55. A through hole 62 is formed in the projection 61 for insertion of each of the support shafts 60. The first lens holder 55 is kept slidable in the optical axis direction by the support shafts 60 received in the through hole 62.

A lens biasing compression coil spring 63 is positioned to receive insertion of each of the support shafts 60, and biases the first lens holder 55 in a backward direction toward the image plane of the photographing lens. The compression coil spring 63 is disposed on the front face of the projection 61. When the first lens holder 55 moves toward the objective side, the compression coil spring 63 is compressed, to create force of recovery to bias the first lens holder 55 backwards.

In FIG. 5, a rod entrance 65 is formed in the rear of the barrier or cover shifting ring 47, and receives advance of the cover closing cam rod 37 of the stationary panel 20. A barrier or cover closing cam block 66 is formed in a chamber defined inside the rod entrance 65, and has an inclined surface extending from the position P1 with a small depth to the position P2 with a great depth. The cover closing cam rod 37 contacts the cover closing cam block 66, and causes the cover shifting ring 47 to rotate in the direction to close the barrier blades or lens cover blades 41 when the movable barrel 15 becomes contained. An inclined guide surface 37a is a portion of an outer surface of the cover closing cam rod 37 at its end, and keeps the cover closing cam rod 37 in contact with the cover closing cam block 66.

When the lens cover blades 41 are open, the position P1 of starting closing is located on an extension of the cover closing cam rod 37. At the time of retracting the movable barrel 15, the cover shifting ring 47 moves backwards with the movable barrel 15 to enter the cover closing cam rod 37 into the rod entrance 65. An end of the cover closing cam rod 37 contacts the cover closing cam block 66 in the position P1 of starting closing. The cover closing cam block 66 converts force of moving back of the movable barrel 15 into rotational force to rotate the cover shifting ring 47. The cover shifting ring 47 rotates against the bias of the ring biasing tension coil spring 50 until the cover closing cam rod 37 reaches the position P2 of completion of the closing. In contrast, when at the time of advance of the movable barrel 15 toward the objective side, the cover closing cam block 66 comes to shift in a direction away from the cover closing cam rod 37. The force of recovery of the tension coil spring 50 rotates the cover shifting ring 47 in a direction to open the lens cover blades 41.

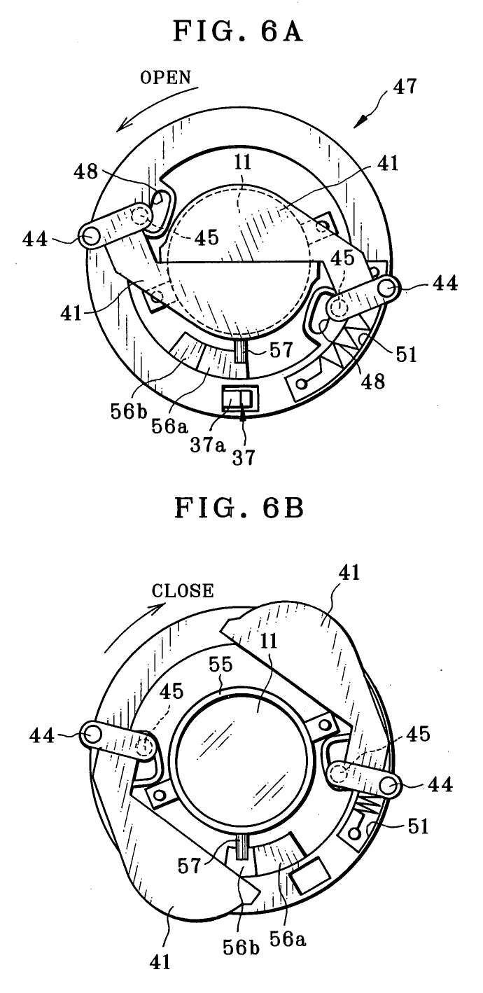

The operation of the zoom lens assembly 10 is described now. In FIG. 6A, the movable barrel 15 stands contained in the stationary barrel 22. The cover closing cam rod 37 enters the rod entrance 65, and keeps the cover shifting ring 47 immovable in the position P2 for completion of the closing. The lens cover blades 41 are closed, and cover the lens opening 42 for entry.

When force of driving of the motor 26 is transmitted to the gear portion 27, the rotatable barrel 21 rotates about the stationary barrel 22. In response, the movable barrel 15 and the second lens holder 16 move toward the objective side. Upon the start of the movable barrel 15 to move forwards, the cover shifting ring 47 becomes gradually separate from the cover closing cam rod 37. The cover shifting ring 47 is rotated by the ring biasing tension coil spring 50 in a direction to open the lens cover blades 41. The engageable hole 48 of the cover shifting ring 47 drives the transmission pin 45 of the lens cover blades 41 to rotate each of the lens cover blades 41 about the rotational support shaft 43. In FIG. 6B, the lens cover blades 41 become open, for the first lens holder 55 to appear through the lens opening 42. The lens cover blades 41 become fully open in the course of rotation of the cover shifting ring 47. The cover shifting ring 47 further rotates even after having become fully open of the lens cover blades 41.

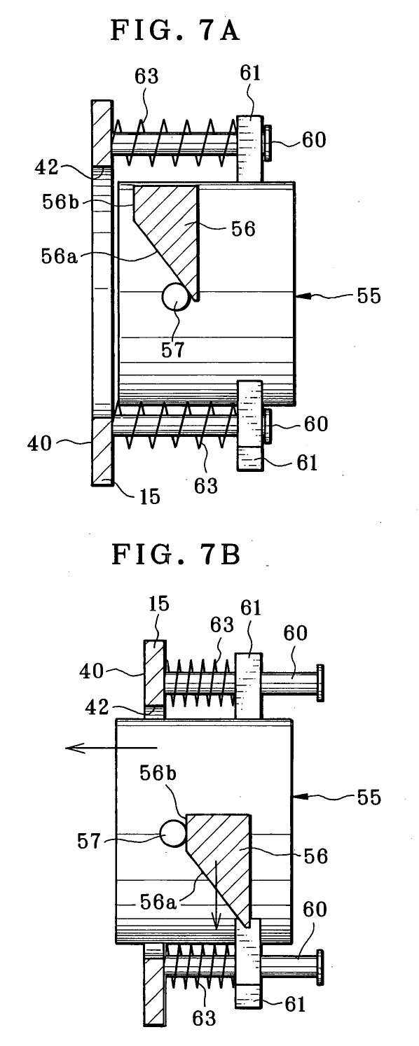

In FIG. 7A, the first lens holder 55, before the movable barrel 15 starts moving toward the objective side, is located behind the lens opening 42 formed in the movable barrel 15. When the cover shifting ring 47 rotates upon the start of moving the movable barrel 15 forwards, the cam follower pin 57 of the first lens holder 55 moves in contact with the inclined cam surface 56a of the lens moving cam block 56. The first lens holder 55 moves forwards against the lens biasing compression coil spring 63.

When the lens cover blades 41 become fully open, the first lens holder 55 reaches the position of the lens opening 42. As the cover shifting ring 47 further rotates even after becoming fully open of the lens cover blades 41, the cam follower pin 57 moves further in contact with the inclined cam surface 56a, to protrude the first lens holder 55 toward the objective side from the level of the lens opening 42. The first lens holder 55 moves forwards further than the position of the lens cover blades 41. In FIG. 7B, the cam follower pin 57 has come to the top of the inclined cam surface 56a when rotation of the cover shifting ring 47 is stopped. The lens biasing compression coil spring 63 biases the first lens holder 55 to press the cam follower pin 57 on the lens moving cam block 56. A top end surface 56b of the lens moving cam block 56 is contacted by the cam follower pin 57 which is in a stopped state.

When the movable barrel 15 moves toward the objective side, the lens cover blades 41 open. The first lens holder 55 comes to protrude from the lens opening 42. After this, the movable barrel 15 moves further forwards. When the movable barrel 15 moves to the position of the maximum advance, driving of the motor 26 is stopped. Rotation of the rotatable barrel 21 and movement of the movable barrel 15 are completed.

To contain the movable barrel 15 into the stationary barrel 22, the motor 26 rotates in a backward direction, to cause the rotatable barrel 21 to rotate in a second direction, which is opposite to the first direction for moving the movable barrel 15 toward the objective side. Thus, the movable barrel 15 starts moving toward the side of the image plane. In the course of backward movement of the movable barrel 15, the cover closing cam rod 37 comes to enter the rod entrance 65 of the cover shifting ring 47. The cover closing cam rod 37 contacts the barrier or cover closing cam block 66 at the position P1 of starting closing, and rotates the cover shifting ring 47.

When the cover shifting ring 47 rotates, the position of the contact of the lens moving cam block 56 with the cam follower pin 57 shifts from the top end surface 56b to the inclined cam surface 56a. The first lens holder 55 is kept by the lens biasing compression coil spring 63 on the side of the image plane. The cam follower pin 57 moves in contact with the inclined cam surface 56a and to the rear position from the position where the first lens holder 55 protrudes forwards from the lens opening 42. When the first lens holder 55 moves backwards from the lens opening 42, the engageable hole 48 rotates about the transmission pin 45 in a direction to close the lens cover blades 41.

When the movable barrel 15 further moves toward the side of the image plane, the cover closing cam rod 37 reaches the position P2 of completing the closing of the cover closing cam block 66. The lens cover blades 41 are completely closed, to cover the lens opening 42. The first lens holder 55 is moved to the rearmost position of its movable range by the lens biasing compression coil spring 63.

The cover shifting ring 47 on the zoom lens assembly 10 rotates in response to movement of the movable barrel 15 in the optical axis direction. Force to rotate the cover shifting ring 47 is transmitted by the engageable hole 48 to the lens cover blades 41, and by the lens moving cam block 56 to the first lens holder 55. Thus, opening and closing operation of the lens cover blades 41 and movement of the first lens holder 55 are carried out.

Various modifications are possible in addition to the above embodiment. In the above embodiment, the cover shifting ring 47 is rotated for closing by rotation of the motor 26. However, an additional motor or actuator may be used for rotating the cover shifting ring 47.

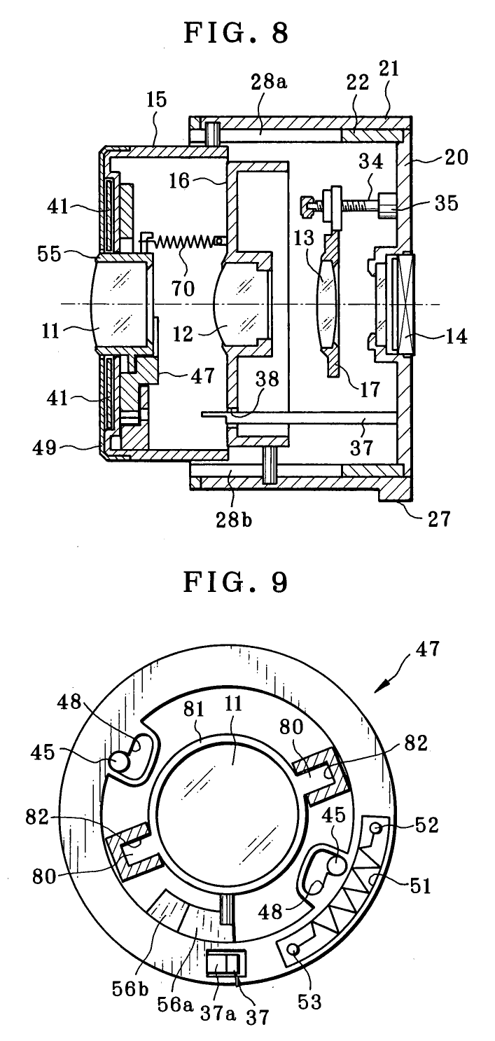

In the embodiment, the lens biasing compression coil spring 63 biases the first lens holder 55 toward the image plane. However, a spring may bias the first lens holder 55 toward the objective side. The lens moving cam block 56 may move the first lens holder 55 backwards. In the above embodiment, the support shafts 60 receive insertion of the compression coil spring 63 on the movable barrel 15. However, a structure of FIG. 8 with a lens supporting tension coil spring 70 as lens support mechanism may be used. One end of the tension coil spring 70 is secured to the first lens holder 55. A second end of the tension coil spring 70 is secured to the second lens holder 16. When the movable barrel 15 is moved forwards, force for recovery of the tension coil spring 70 occurs upon the enlargement of the interval between the first lens holder 55 and the second lens holder 16. Thus, the first lens holder 55 can be biased backwards.

As lens support mechanism, it is possible to use a structure distinct from the support shafts 60 for the first lens holder 55. In FIG. 9, one preferred embodiment is illustrated. A first lens holder 81 has a guide ridge 80 as lens support mechanism. The guide ridge 80 is formed on the peripheral surface of the first lens holder 81 and extends in the axial direction. A guide channel 82 is formed in the movable barrel, and receives the guide ridge 80. The first lens holder 81 is kept slidable by the guide ridge 80 and the guide channel 82 in the structure without the support shafts 60.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A lens assembly comprising:
a lens barrel;
a photographing lens system, contained in said lens barrel, and having a first lens disposed on an objective side;
a lens opening, formed in a front end of said lens barrel, for entry of object light to said first lens;
a lens cover blade movable between an open position to open said lens opening and a closed position to close said lens opening;
a lens support mechanism for supporting said first lens movably along an optical axis between a front position and a rear position, wherein said first lens, when in said front position, is located in said lens opening at least partially, and when in said rear position, is positioned behind and away from said lens opening; and
a lens moving mechanism, responsive to shifting of said lens cover blade, for moving said first lens so as to prevent said lens cover blade from interfering with said first lens.

2. A lens assembly as defined in claim 1, wherein said lens barrel is movable forwards toward an objective side for photographing, and backwards after photographing for collapsing.

3. A lens assembly as defined in claim 2, further comprising a cover moving mechanism for shifting said lens cover blade in connection with said lens barrel, to set said lens cover blade in said open position when said lens barrel is moved forwards, and to set said lens cover blade in said closed position when said lens barrel is moved backwards for collapsing.

4. A lens assembly as defined in claim 3, wherein said lens moving mechanism is responsive to a shift of said lens moving mechanism, and said first lens, when said lens cover blade is moved to said open position, is set in said front position, and when said lens cover blade is moved to said closed position, is set in said rear position.

5. A lens assembly as defined in claim 1, wherein said cover moving mechanism has a rotatable cover shifting ring for shifting said lens cover blade.

6. A lens assembly as defined in claim 5, wherein said lens moving mechanism includes:
a first biasing device for biasing said first lens toward said rear position;
a first cam device, responsive to rotation of said cover shifting ring, for moving said first lens toward said front position against said first biasing device.

7. A lens assembly as defined in claim 6, wherein said first cam device includes:
a cam follower pin formed to project from a first lens holder of said first lens;
a cam block, formed to project from said cover shifting ring, having a cam surface, for pressing said cam follower pin when rotated, to move said first lens toward said front position.

8. A lens assembly as defined in claim 7, wherein said lens support mechanism includes plural support shafts, secured to said lens barrel, for supporting said first lens holder movably.

9. A lens assembly as defined in claim 8, wherein said first biasing device is secured to said support shafts.

10. A lens assembly as defined in claim 8, wherein said photographing lens system includes a second lens disposed behind said first lens;
said first biasing device extends between said first lens holder and a second lens holder having said second lens positioned therein.

11. A lens assembly as defined in claim 7, wherein said lens support mechanism includes:
a guide channel formed inside said lens barrel to extend along said optical axis;
a guide ridge, formed to project from said first lens holder, and guided by said guide channel.

12. A lens assembly as defined in claim 6, wherein said cover moving mechanism includes:
a transmission pin for projecting from said lens cover blade;
an engageable hole, formed in said cover shifting ring, for receiving an end of said transmission pin, and for rotating said transmission pin about a rotational center upon rotation of said cover shifting ring.

13. A lens assembly as defined in claim 6, wherein said cover moving mechanism includes:
a second cam device, responsive to moving of said lens barrel to a back position for containing, for rotating said cover shifting ring in a closing direction;
a biasing device for biasing said cover shifting ring in an opening direction.

14. A lens assembly as defined in claim 13, further comprising a stationary panel, disposed behind said lens barrel, for supporting said lens barrel movably;
wherein said second cam device includes:
a cam rod formed to project forwards from said stationary panel;
a cam block, formed with said cover shifting ring, having a cam surface, for being pressed by said cam rod when said lens barrel is in said back position, to rotate said cover shifting ring in said closing direction.

15. A camera comprising:
a lens barrel, movable forwards toward an objective side for photographing, and backwards after photographing for collapsing;
a photographing lens system, contained in said lens barrel, and having a first lens disposed on an objective side;
a lens opening, formed in a front end of said lens barrel, for entry of object light to said first lens;
a lens cover blade movable between an open position to open said lens opening and a closed position to close said lens opening;
a lens support mechanism for supporting said first lens movably along an optical axis between a front position and a rear position, wherein said first lens, when in said front position, is located in said lens opening at least partially, and when in said rear position, is positioned behind and away from said lens opening; and
a lens moving mechanism, responsive to shifting of said lens cover blade, for moving said first lens so as to prevent said lens cover blade from interfering with said first lens.

16. A camera as defined in claim 15, further comprising a cover moving mechanism for moving said lens cover blade in connection with said lens barrel, to move said lens cover blade to said open position when said lens barrel is moved forwards, and to move said lens cover blade to said closed position when said lens barrel is moved for collapsing.

17. A camera as defined in claim 16, wherein said lens moving mechanism is responsive to a shift of said lens moving mechanism, and said first lens, when said lens cover blade is moved to said open position, is set in said front position, and when said lens cover blade is moved to said closed position, is set in said rear position.
